(19) United States
(12) Patent Application Publication
(10) Pub. No.: US 2005/0087357 A1
(43) Pub. Date: Apr. 28, 2005

(54) Cable feed-through

(76) Inventor: Klaus Manfred Steinich, Zorneding/Poring (DE)

Correspondence Address: HEAD, JOHNSON & KACHIGIAN, 228 W 17TH PLACE, TULSA, OK, 74119, US

(21) Appl. No.: 10/963,177

(22) Filed: Oct. 12, 2004

(30) Foreign Application Priority Data
Oct. 20, 2003 (DE) 20316059.2

(51) Int. Cl. H02G 3/18

(52) U.S. Cl. 174/65 R

(57) ABSTRACT

A tension-relief cable feed-through for an electrical cable having an external diameter with insulation therearound and having a feed-through sleeve having a passageway therethrough which has an internal thread with an internal diameter having thread turns with indentations therebetween such that when the electrical cable is screwed into the passageway the thread turns of the internal thread press in a form-closing manner into the outer circumference ofthe insulation surrounding the electrical cable.

### FIELD OF APPLICATION

The invention relates to a tension-relief feed-through of an electric cable through a solid component, for instance a housing component, in particular a housing cover.

### TECHNICAL BACKGROUND

Since the electric contact of the cores of a cable with the component to be connected, for example an electronic board, cannot usually bear any larger amount of mechanical forces, a so-called tension-relief is very often required for electric connecting cables. This serves to prevent a snapping of the electric connection between the cable and the remainder of the electric device if the cable is pulled too much.

To this end the cable is in most cases connected to the housing component in a mechanically fixed manner at the passage portion through the housing component, for example by being clamped by means of a tightening clamping rail on a foundation such as the housing component. Tension-relief devices of such kind require an additional constructional space and, in the case described here, a tightening of at least two screws during the assembly.

Another commonly used tension-relief is to feed a cable through the passage of a feed-through sleeve which possesses an external thread at its outer circumference. A coupling nut, which has been threaded onto the cable prior to the feed-through of the cable and has an internal thread that fits onto the external thread and likewise possesses a passage for the cable, can be screwed onto the feed-through sleeve after the cable has been fed through. As a result, the free internal cross section of the feed-through sleeve is being pressed together which is due to a conical design either of this internal cross section and/or of the thread.

However, on account of the conicity the production of such a feed-through sleeve proves to be complicated and an additional component in the form of a coupling nut is required and during the assembly the preceding threading of the coupling nut onto the cable must not be forgotten, as this may otherwise lead to an additional amount of work.

### REPRESENTATION OF THE INVENTION

a) Technical Problem

Therefore the object in accordance with the invention is to develop a tension-relief which can be produced and assembled in a simple and cost-effective manner.

b) Solution of the Problem

This object is solved by the characterizing features of claim 1. Advantageous embodiments become apparent from the subclaims.

Provided that the external diameter of the cable is larger in the tension-relieved condition than the free passage of the internal thread of the passage, the thread turns of the internal thread press into the outer circumference of the insulation, and hence the outer circumference of the cable, as soon as the cable is located in the axial length portion of the thread.

In this manner an axially tight connection is established between the cable and the feed-through sleeve and thus a tension-relief.

To achieve this it must be ensured on the one hand that the insulation of the cable has a sufficient thickness so that the thread turns that press into the outer circumference cannot reach or damage the cores in the inside of the insulation.

On the other hand the external diameter of the cable should not be of such a large dimension that its insertion into the axial portion of the internal thread requires too great an expenditure of force, for instance if in the tension-relieved condition the external diameter of the cable is considerably larger than the nominal diameter of the thread, hence the diameter measured between the indentations of the thread turns.

The cable can be inserted into the axial length portion of the internal thread by advancing the cable axially, which, however, requires a relatively great expenditure of force.

A less quick but more reliable method of insertion is to screw the feed-through sleeve with the internal thread of the passage onto the external diameter of the cable, i.e. its insulation.

Especially if the thread turns are designed in a sufficiently pointed manner so that they cut into the plastic material of the cable insulation, a connection is provided between both parts that is of particular axial tightness.

Apart from the kind of insulation, which usually is a plastic material, and its absolute tensile strength, the tensile-loaded capacity of this connection depends on the prestressing of the insulation in the radial direction. By preference, the external diameter of the cable is therefore slightly larger in the initial condition than the nominal diameter of the internal thread.

In order that the first turn of the internal thread in the screwing direction still seizes the insulation of the cable without too great an expenditure of force, there are several possibilities as stated below: 25

Either the passage including the internal thread, hence also the nominal diameter of the internal thread, is tapered in the screwing direction of the cable. In this case, the external diameter of the cable is smaller in the initial condition than the nominal diameter of the thread at the wide end but larger than the nominal diameter at the narrow end.

Another solution is to leave the nominal diameter of the thread unchanged but to design the first thread turns in the screwing direction with a smaller pitch of the thread turns and to reach the complete thread pitch in the course of the first thread turns.

Both possibilities are costly, since they can hardly be reconciled with the standardized, cost-effective production methods for threads.

A third possibility resides in the fact that the internal thread and also the passage in the portion of the internal thread are not of a conical design but that in the inserting direction of the cable a feeding pipe in the form of an extension of the passage is prearranged before the internal thread coaxially thereto and that the internal diameter of this feeding pipe is designed conically with a narrowing towards the internal thread.

Preferably, the free diameter of the feeding pipe then corresponds approximately to the nominal diameter of the internal thread at the end facing towards the internal thread.

Inasmuch as the electric cable concerned here is a cable with a shielding, i.e. with a mesh of metal filaments contained in the insulation coaxially between the outer circumference of the cable and the cores in the inside of the cable, the insulation is removed at an axial end portion of the cable prior to the insertion into the passage of the feed-through sleeve so that the cores of the cable project axially by this length from the removed insulation. In doing so the shielding is not removed together with the insulation but kept long, i.e. it is cut according to the length of the cores, and before the insertion, i.e. the screwing-in or advancing of the insulation of the cable into the internal thread of the passage, it is bent backwards onto the external diameter of the insulation.

If the cable is then inserted into the passage only to such an extent that the insulation of the cable projects scarcely or to a minimum from the axial portion of the internal thread and if the shielding has been bent at least with a projecting length from the insulation in accordance with the axial length of the internal thread, the filaments or the mesh of the shielding is located between the outer circumference of the insulation of the cable and the internal thread of the passage and consequently in an electrically conductive contact with the internal thread.

If the feed-through sleeve consists of an electrically conductive material, such as metal, the shielding is thereby brought into electric contact with the feed-through sleeve and thus with the housing of the electric device to be connected.

As a result, a reliable sealed EMI-shielding of the cable is ensured on the one hand and on the other hand the tension-relief is influenced in a positive way, as the metal filaments of the shielding that extend in the axial direction along the internal thread additionally increase the tensile-loaded capacity of the connections.

In addition, the tensile-loaded capacity of the cable can be improved, especially when the latter is provided with a shielding, if the shielding projects at the face of the insulation and is not cut and if at least the shielding, preferably also the insulation of the cable, is bonded to the housing into which the cable is inserted. Owing to the numerous single wires or fibers of the shielding, which are mostly arranged in a mesh-like or web-like fashion, a highly form-locking connection with a resultant high load capacity is established between the cured sealing compound and the shielding and consequently an additionally improved tensile capacity is achieved.

### EMBODIMENTS

In the following a detailed description of an embodiment according to the invention will be given by way of example with reference to the Figures.

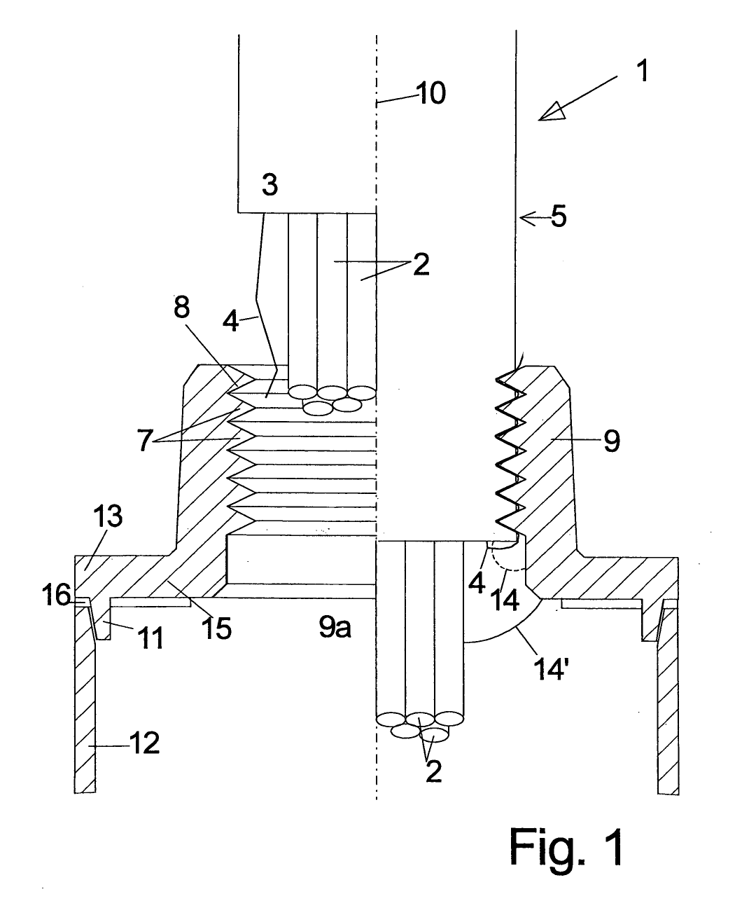

FIG. 1: shows a cross section through a first tension-relief according to the invention, in which only the right-hand part of the illustration shows the cable already located in the feed-through sleeve;

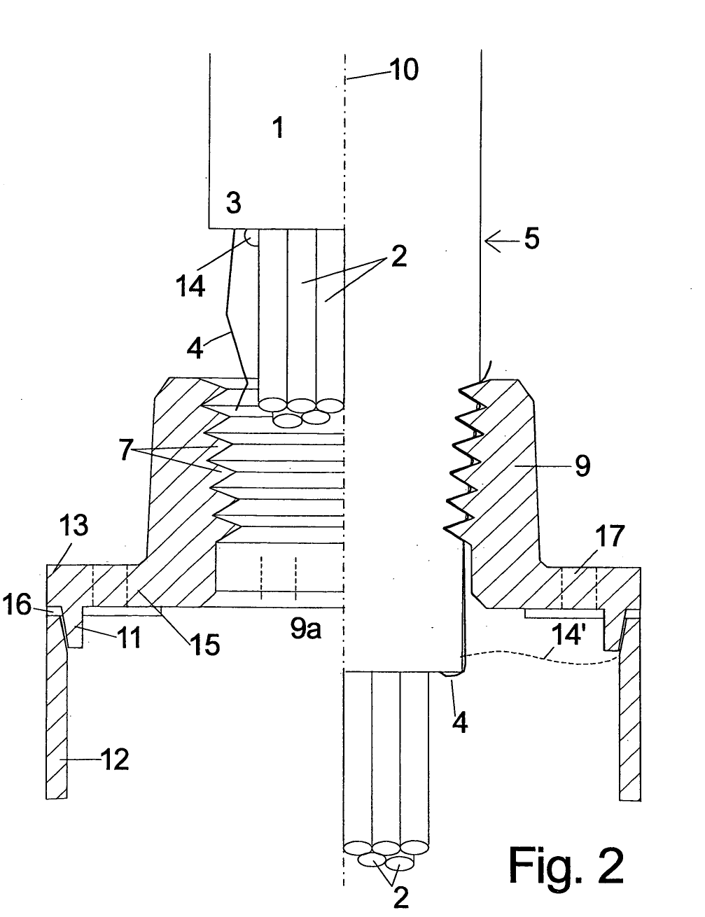

FIG. 2: shows a second embodiment and

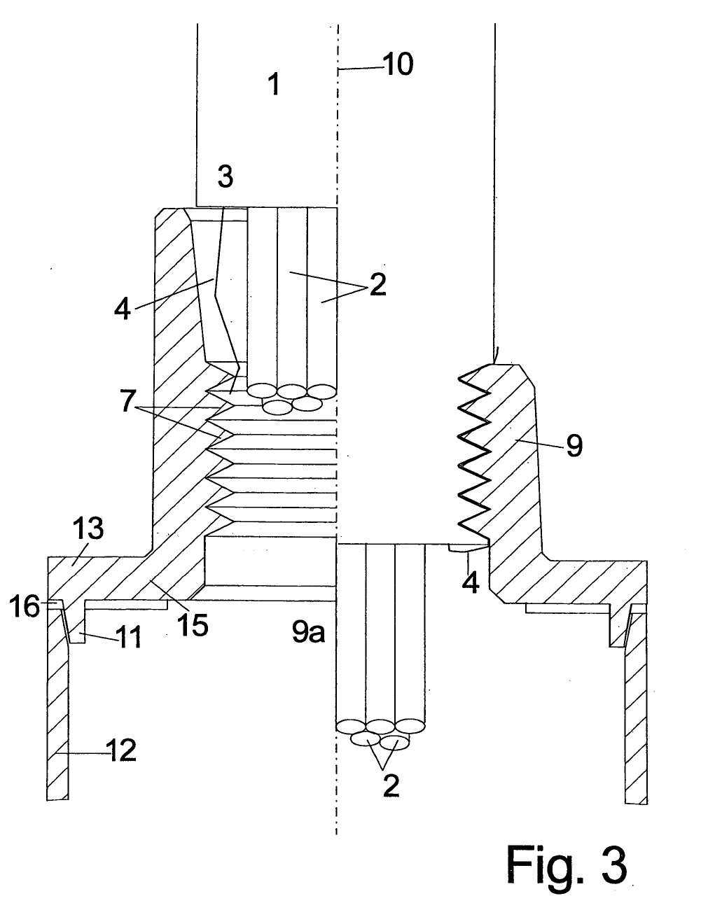

FIG. 3: shows a third embodiment.

FIG. 1 is a longitudinal cross section showing the cable passage prior to the completion in the left half of the illustration and in the right half of the illustration in the completed state, i.e. after the cable 1 is located with its insulation 3 in the axial length portion of the internal thread 8.

The feed-through sleeve 9 has an internal thread 8, which usually has a rotationally symmetrical circular cross section, and here the feed-through sleeve 9 can be formed as an integral part of a cover 15 that is placed e.g. onto a profile 12 or a housing.

The feed-through sleeve 9 extends from the principal plane of the cover 15 into one direction, while for instance guide extensions 11 extend into the other direction which facilitate a precise fitting of the cover 15 onto the adjoining component so as to permit afterwards the screwing through the cover against the profile 12, preferably by interposing e.g. a flat sealing 16.

In the inside of the profile 12 the cores 2, which project sufficiently in the longitudinal direction 10 from the insulation 3 of the cable 1 that was removed in the end portion of the latter, are to be connected with an electric component in the inside e.g. of the profile 12.

As shown in FIG. 1, the external diameter 5 of the cable 1 is approximately of the same length in the initial condition as the nominal diameter N of the internal thread 8. The cable 1 can therefore be screwed in from the outside with its insulation 3 into the internal thread 8 of the feed-through sleeve 9. After the first thread turns have sunk into the external diameter of the insulation 3, a form closure between both parts has already been established to an increasing extent during the gradual screwing-in, which form closure permits a retraction or advancing at a great expenditure of force only so that the most force-saving inserting direction proves to be the screwing-in which is preferably carried out until the front end of the insulation has just passed completely through the internal thread 8.

If the cable 1 has an electromagnetic shielding 4 in the form of a metal wire mesh in the proximity of the outer circumference and within the insulation 3 and thus concentrically around the cores 2, and if particularly this shielding of the cable is to be maintained, the shielding 4 is cut to length together with the cores 2, as a result of which it projects from the insulation 3 that was cut to a shorter length.

Before the insertion of the cable 1 into the internal thread 8 this shielding 4 is bent backwards and thereby placed onto the external diameter of the cable 1—as depicted in the right half of the illustration—and during the screwing-in or insertion it is located between the internal thread 8 and the insulation 3. If the internal thread 8, by preference the entire cover 15, consists of an electrically conductive material, in particular metal, the cable 1 is thus connected in an EMI-sealed manner to the cover 15 and consequently to the housing of the electric device.

Apart from the feed-through sleeve 9 itself, there is no further component required for the described tension-relief cable feed-through, not even an additional fixing screw for the cable mounting, and the assembly is effected as quickly as the tightening of only one fixing screw.

Furthermore, in the right half of the illustration FIG. 1 shows a track of cured adhesive or cured sealing compound 14 that is preferably provided over the entire circumference in the corner portion between the free face of the insulation 3 of the cable and the internal circumference of the feed-through sleeve 9. For this purpose the cable 1 is advanced or screwed through the internal thread 8 only to such an extent that the internal diameter of the feed-through sleeve 9 is still located close to the external diameter 5 of the cable 1. The adhesive/the sealing compound 14′ can also extend across the entire face of the cable 1 as far as the feed-through sleeve 9.

This bonding serves to improve the tensile-loaded capacity of the cable 1 which is therefore not only brought about by the form-closing engagement of the thread turns of the internal thread 8 into the insulation 3 of the cable but also by the bonding between the feed-through sleeve 9 and the insulation 3 and also between the shielding 4, provided that it also extends through this compound 14 and is bonded thereto.

FIG. 2 differs from FIG. 1 in that the passage 9a including the internal thread 8 is designed conically, i.e. it has a tapered cross section in the screwing direction of the cable 1, whereby the screwing-in of the cable 1 is facilitated due to the fact that the first thread turns can be screwed easily and reliably onto the external diameter at the beginning of the cable.

This is facilitated in particular due to the fact that the external diameter 5 of the cable 1 is larger than the free passage at the second, free end of the passage, yet larger than the free passage at the inner, narrow end of the passage, in particular also larger than the internal diameter N.

Furthermore, FIG. 2 also differs from FIG. 1 in that a sealing compound 14′ is not just applied as a single track but that it substantially covers the housing 12 completely onto which the cover 15 with the feed-through sleeve 9 is placed. In order to be able to effect this after the placing of the cover 15, at least two openings 17 are provided in the cover 15, preferably on opposite sides with respect to the feed-through sleeve 9, of which one opening serves to fill in the sealing compound 14′ after the placing of the cover 15, while the other opening serves to exhaust the air displaced thereby inside the housing.

To further improve the tensile-loaded capacity of the cable 1, the cable 1 is in this case screwed to such an extent into the feed-through sleeve 9 and therethrough that the cable 1 projects with its insulation 3, and consequently also with the shielding 4 that may emerge at the face of the insulation and is bent backwards, into the bonding portion and is bonded, too. Especially the bonding of the shielding 4, which is in most cases designed in a mesh-like or netting-like manner, leads to a strong, form-closing and also force-locking connection of the cable 1 with the sealing compound 14′, whereby the cable is connected in a fixed manner to the housing or profile.

In FIG. 3 the internal thread 8 is designed with a constant diameter over the entire length, just as in the solution according to FIG. 1, but in the inserting direction of the cable 1 a feeding pipe 6 is arranged before the internal thread 8 which is in particular designed integrally with the feed-through sleeve 9.

The internal diameter of the feeding pipe 6 is tapered towards the internal thread 8, while the external diameter 5 of the cable is smaller than the internal diameter of the feeding pipe 6 at its free, open end, but larger than at least the free passage of the internal thread 8, preferably also larger than the internal diameter N of the internal thread 8.

### List of Reference Signs

1 cable
2a,b cores
3 insulation
4 shielding
5 external diameter
6 feeding pipe
7 thread turn
8 internal thread
9 feed-through sleeve
9a passage
10 longitudinal direction
11 guide extension
12 profile
13 screwing
14 sealing compound
15 cover
16 sealing
n nominal diameter

1. (canceled)

2. A tension-relief cable feed-through according to claim 14, wherein in an initial condition the external diameter of said electrical cable is larger than the diameter of said internal thread as measured between said indentations between said thread turns.

3. (canceled)

4. A tension-relief cable feed-through according to claim 20 wherein at the inner, smaller end the internal diameter of the feeding pipe corresponds to the diameter of said internal thread between said thread turns.

5. A tension-relief cable feed-through according to claim 14 wherein said electrical cable further includes;
a plurality of cores; and
a metal shielding between the plurality of cores and said external diameter resting on the external diameter of said electrical cable by protruding from a free end of said electrical cable and being bent backwards, thus being located between said internal thread of said feed-through sleeve and said insulation of said electrical cable.

6. A tension-relief cable feed-through according to claim 5 wherein the backward bent metal shielding has an axial extension corresponding at least to an axial length of said internal thread.

7. A tension-relief cable feed-through according to claim 14 wherein said insulation of said electrical cable is thicker than a pitch of said thread turns.

8. A tension-relief cable feed-through according to claim 14 wherein in a relieved condition said external diameter of said electrical cable is not larger than a nominal diameter (N) of said internal thread by more than 20%.

9. A tension-relief cable feed-through according to claim 14 wherein said feed-through sleeve is a sheet-metal part, and said internal thread is manufactured as a threaded nozzle.

10. A tension-relief cable feed-through according to claim 14 wherein said internal thread consists of an electrically conductive material.

11. A tension-relief cable feed-through according to claim 14 wherein an adhesive or a sealing compound is arranged such that it is bonded to both said insulation of said electrical cable and an inner circumference of said passageway.

12. A tension-relief cable feed-through according to claim 14 wherein an adhesive or sealing compound includes at least partially said metal shielding of said electrical cable .

13. A tension-relief cable feed-through according to claim 14 wherein said electrical cable is screwed to such an extent into said internal thread of said feed-through sleeve that it protrudes axially at an inner side of said feed-through sleeve and projects into an adjoining housing whilst being surrounded at least with said metal shielding by a sealing compound provided in the adjoining housing.

14. A tension-relief cable feed-through, said feed-through comprising:
an electrical cable having an external diameter with insulation therearound forming an outer circumference; and
a feed-through sleeve having a passageway therethrough the passageway having an internal thread having an internal diameter with thread turns with indentations therebetween such that when the electrical cable is screwed into the passageway, the thread turns of the internal thread press in a form-closing manner into the outer circumference of the insulation surrounding the electrical cable.

15. A tension-reliefcable feed-through according claim 14 wherein an adhesive or sealing compound includes at least partially said metal shielding of said electrical cable in the portion between the exit of said metal shielding from a face of said insulation and an entrance of said metal shielding into said internal thread.

16. A tension-relief cable feed-through according to claim 14 wherein said feed-through sleeve is manufactured as a stamped metal part.

17. A tension-relief cable feed-through according claim 14 wherein the entire feed-through sleeve consists of electrically conductive material such as metal.

18. A tension-relief cable feed-through according to claim 14 wherein an adhesive or a sealing compound is applied in an annular manner and arranged such that it is bonded to both said insulation of said electrical cable and an inner circumference of said passageway.

19. A tension-relief cable feed-through according claim 14 wherein said electrical cable is screwed to such an extent into said internal thread of said feed-through sleeve that it protrudes axially at an inner side of said feed-through sleeve and projects into an adjoining housing whilst being surrounded at least with said metal shielding and with said insulation of said electrical cable by a sealing compound provided in the adjoining housing.

20. A tension-relief cable feed-through said feed-through comprising:
an electrical cable having an external diameter with insulation therearound forming an outer circumference;
a feed-through sleeve having a passageway therethrough, the passageway having an internal thread having an internal diameter with thread turns with indentations therebetween such that when the electrical cable is screwed into the passageway, the thread turns of the internal thread press in a form-closing manner into the outer circumference of the insulation surrounding the electrical cable; and
a prearranged, conical-shaped feeding pipe having a free end and an inner small end and a passageway therethrough, and further having an internal diameter which decreases towards said internal thread of said feed-through sleeve, the free end diameter being larger than the external diameter of the electrical cable in its initial condition and the inner small end being smaller than the external diameter of the cable in the initial condition.

21. A tension-relief cable feed-through according to claim 20 wherein said electrical cable further includes:
a plurality of cores; and
a metal shielding between the plurality of cores and said external diameter resting on the external diameter of said electrical cable in an initial condition and after being fed through said feed-though sleeve and protruding from a free end of said electrical cable and being bent backwards, thus being located between said internal thread of said feed-through sleeve and said insulation of said electrical cable.

22. A tension-relief cable feed-through according claim 21 wherein the backward bent metal shielding has an axial extension corresponding to at least an axial length of said internal thread.

23. A tension-relief cable feed-through according to claim 20 wherein said insulation of said electrical cable is thicker than a pitch of said thread turns.

24. A tension-relief cable feed-through according to claim 20 wherein in a relieved condition said external diameter of said electrical cable is not larger than a nominal diameter of said internal thread by more than 20%.

25. A tension-relief cable feed-through according to claim 20 wherein said feed-through sleeve is a sheet-metal part and said internal thread is manufactured as a threaded nozzle.

26. A tension-relief cable feed-through according to claim 20 wherein said internal thread consists of an electrically conductive material.

27. A tension-relief cable feed-through according to claim 20 wherein the entire feed-through sleeve consists of an electrically conductive material.

28. A tension-relief cable feed-through according to claim 20 wherein an adhesive or a sealing compound is arranged such that it is bonded to both said insulation of said electrical cable and an inner circumference of said passageway.

29. A tension-relief cable feed-through according to claim 20 wherein an adhesive or a sealing compound is applied in an annular manner and arranged such that it is bonded to both said insulation of said electrical cable and an inner circumference of said passageway.

30. A tension-relief cable feed-through according claim20 wherein an adhesive or sealing compound includes at least partially said metal shielding of said electrical cable in the portion between an exit of said metal shielding from a face of said insulation and an entrance of said metal shielding into said internal thread.

31. A tension-relief cable feed-through according to claim 20 wherein said electrical cable is screwed to such an extent into said internal thread of said feed-through sleeve that it protrudes axially at an inner side of said feed-through sleeve and projects into an adjoining housing whilst being surrounded at least with said metal shielding by a sealing compound provided in the adjoining housing.

32. A tension-relief cable feed-through according to claim 20 wherein in an initial condition the external diameter of said electrical cable is larger than the diameter of said internal thread as measured between said indentations between said thread turns.

33. A tension-relief cable feed-through according to claim 20 wherein said feed-through sleeve is manufactured as a stamped metal part.

34. A tension-relief cable feed-through according claim 20 wherein said electrical cable is screwed to such an extent into said internal thread of said feed-through sleeve that it protrudes axially at an inner side of said feed-through sleeve and projects into an adjoining housing whilst being surrounded at least with said metal shielding and with said insulation of said electrical cable by a sealing compound provided in the adjoining housing.
